(19) United States
(12) Patent Application Publication
(10) Pub. No.: US 2011/0028679 A1
(43) Pub. Date: Feb. 3, 2011

(54) Polyamides Prepared From Long-Chain Dicarboxylic Acids and Methods for Making the Polyamides

(75) Inventors: Jianhua Mao, West Chester, OH (US); Mark Durchholz, West Chester, OH (US); Manfred Biermann, Butte, MT (US)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, Duesseldorf (DE)

(21) Appl. No.: 12/744,725

(22) PCT Filed: Nov. 25, 2008
(86) PCT No.: PCT/EP08/09974

§ 371 Date: Oct. 19, 2010

Related U.S. Application Data
(60) Provisional application No. 60/990,075, filed on Nov. 26, 2007.

(51) Int. Cl. C08G 69/26

(52) U.S. Cl. 528/345; 528/335

(57) ABSTRACT

Polyamides according to formula (I): HO—[OC—(CH₂)₇—CH═CH—(CH₂)₇—CONH—(CH₂)ₘNH]ₙH, where m is an integral number from 4 to 20, and n is an integral number from 30-10,000; formula (II): HO—[OC—(CₓH_{2x-2y})—CONH—(CₐH_{2a-2b})NH]ₙH where n is an integral number from 30-10,000, a and x each represent a value from 6-32, and b and y each represent a value from 0-12; formula (III): HO—{[OC—(CH₂)₁₆—CONH—(CH₂)₆NH]ₓ—[CO—C₆H₄—CONH—(CH₂)₆NH]_{y}}_{a+b}—H, where a+b=n; a, b, n are integral numbers; and n represents a number from 30-10,000; and formula (IV): HO—{[OC—R₁—CONH—R₃—NH]ₓ—[CO—R₂—CONH—R₄₋—NH]_{y}—[OC—R₁—CONH—R₄—NH]_{c}—[CO—R₂—CONH—R₃₋—NH]_{d}}—H, where R₁ and R₃ are aliphatic with 4-22 carbon atoms; R₂ and R₄ are aromatic with 6-20 carbon atoms; a, b, m, n, and c, d, x, and y are integral numbers, c+d+x+y=a+b=m+n and equals 30 to 10,000 are provided. Methods for making the polyamides are also provided.

### FIELD OF THE INVENTION

The invention relates generally to polyamides, and more particularly to polyamides prepared from long-chain dicarboxylic acids via bio-oxidation.

### BACKGROUND INFORMATION

Long-chain aliphatic dicarboxylic acids (diacids) with nine or more carbon atoms may be used as intermediates in the synthesis of a wide variety of chemical products, for example, plastics and polymer formation, and other specialty chemicals used in perfumes and adhesives.

Diacids are currently produced mainly by non-biological conversion processes using non-renewable petrochemical feedstock. The multi-step chemical conversion processes typically produce unwanted hazardous by-products which result in yield losses, and which must be destroyed before releasing to the environment. Disposal of a hazardous waste stream may be expensive, which adds to the cost of production.

In addition, organic chemical synthesis of long-chain diacids is limited by the starting materials used, and thus, each chemical synthesis process produces only one species of diacid. For example, dodecanedioic acid is produced by a multi-step chemical conversion process that has considerable limitations and significant disadvantages. Since the starting material in the synthesis is butadiene (a 4-carbon petrochemical), the only diacids which are synthesized are those having four carbon atoms, or a number which is a multiple of four. In practice, however, only dodecanedioic acid is produced from butadiene by this process, due to economic and product performance reasons. Dodecanedioic acid is the longest straight chain diacid currently available using an industrial chemical synthesis process. The process, however, produces unwanted by-products, including cyclooctadiene and vinyl cyclohexene, which results in yield losses. The process also produces nitrogen oxides, which may be released to the atmosphere or destroyed in a reduction furnace.

Currently, only three diacids ranging in length from nine (9) carbon atoms to twelve (12) carbon atoms are commercially available for polymer applications, all of which are produced via chemical synthesis. The use of chemical synthesis has not been commercially viable for producing polymer-grade diacids with more than twelve (12) carbon atoms. Diacids may be produced by microbial oxidation of alkanes and fatty acids, but commercialization has been limited by the high cost of production, and the low purity of existing diacid supplies.

Diacids can be used as monomers, in reactions with diamines, to form polyamides. Polyamides have been developed for more than sixty years. Polyamides and copolyamides are among the most widely used engineering resins. Polyamide materials are used in various applications, for example, in brush applications, including toothbrushes, abrasive brushes, and paint brushes. These applications require good moisture, abrasion, and fatigue resistance. In addition, these applications also may require that the materials exhibit resistance to solvents.

Polyamide materials may be used in food, medicine, and cosmetic packages, which require suitable barrier properties against oxygen, carbon dioxide, and moisture. In some applications, transparence is required, for example, in a bag for carrying blood. One material currently in use is polyvinylchloride (PVC), but the plasticizer used in PVC may contaminate the contents.

There remains a need for improved properties of polyamides and copolyamides, and there also remains a need for a replacement for PVC.

### SUMMARY OF THE INVENTION

Briefly described, according to an aspect of the invention, a polyamide according to general formula (I):

HO—[OC—(CH₂)₇—CH═CH—(CH₂)₇—CONH—(CH₂)ₘNH]ₙH (I)

wherein m is an integral number from 4 to 20, and n is an integral number of 30 to 10,000 is provided.

According to another aspect of the invention, a polyamide according to general formula (II):

HO—[OC—(CₓH_{2x-2y})—CONH—(CₐH_{2a-2b})NH]ₙH (II)

wherein n is an integral number from 30 to 10,000, a and x each represent a value from 6-32, and b and y each represent a value from 0-12 is described.

According to another aspect of the invention, a polyamide according to general formula (III):

HO—{[OC—(CH₂)₁₆—CONH—(CH₂)₆NH]ₓ—[CO—C₆H₄—CONH—(CH₂)₆NH]_{y}}_{a+b}—H (III)

where a+b=n; a, b and n are integral numbers; and n represents a number from 30 to 10,000, and x represents a value from 6-32, and y each represents a value from 0-12.

According to another aspect of the invention, a polyamide according to general formula (IV):

HO—{[OC—R₁—CONH—R₃—NH]ₓ—[CO—R₂—CONH—R₄₋—NH]_{y}—[OC—R₁—CONH—R₄—NH]_{c}—[CO—R₂—CONH—R₃₋—NH]_{d}}—H (IV)

where R₁ and R₃ are aliphatic with chains of 4 to 22 carbon atoms; R₂ and R₄ are aromatic and have chains of 6 to 20 carbon atoms; c, d, x, and y are integral numbers, and the sum of c+d+x+y equals 30 to 10,000 is also described.

According to yet another aspect of the invention, a method for preparing a polyamide includes the steps of: reacting equimolar quantities of a dicarboxylic acid with a diamine in a reactor; removing residual air by vacuum and purging with N₂; heating the reaction mixture under vacuum at 250-350° C. while removing the by-product, i.e., water, is also provided. The degree of polymerization is controlled by the molecular weight or viscosity.

### BRIEF DESCRIPTION OF THE DRAWINGS

FIGS. 1-5 illustrate the properties of a polyamide prepared according to an aspect of the invention;

FIGS. 6-12 illustrate the properties of another polyamide prepared according to an aspect of the invention;

FIGS. 13-15 illustrate the properties of another polyamide prepared according to an aspect of the invention; and

FIG. 16 illustrates the thermal properties of the polyamides of FIGS. 1-15.

FIGS. 17-19 illustrates the properties of another polyamide according to an aspect of the invention.

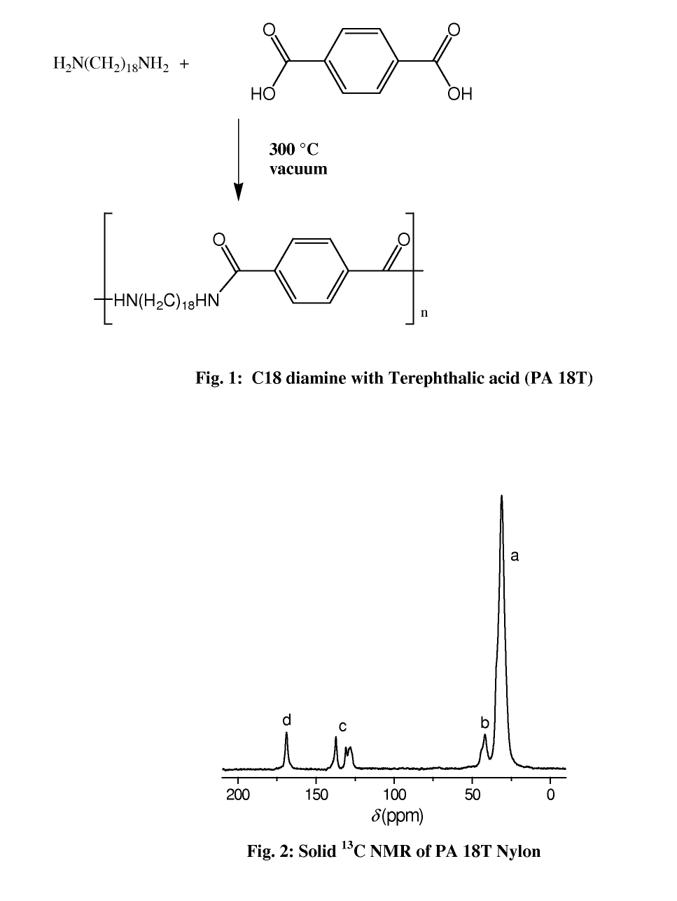

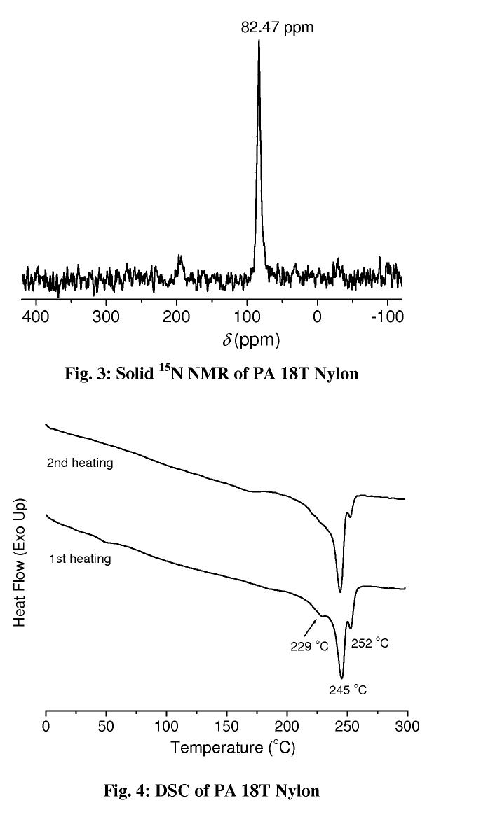

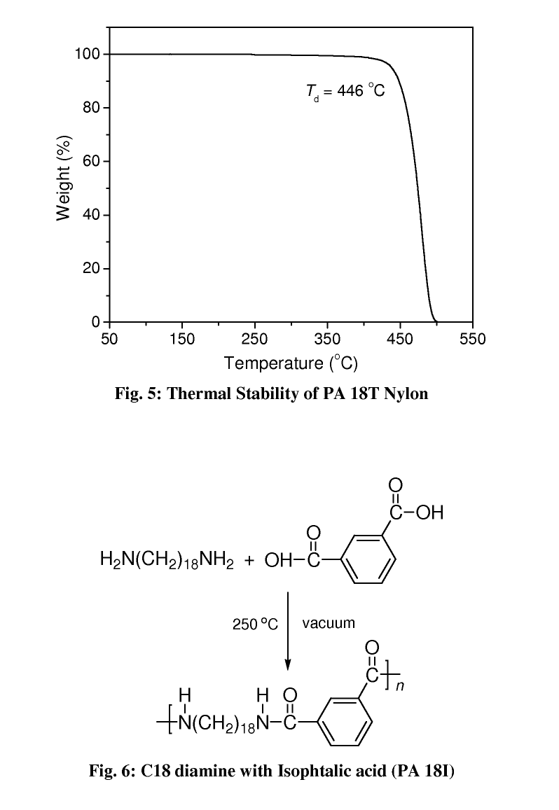

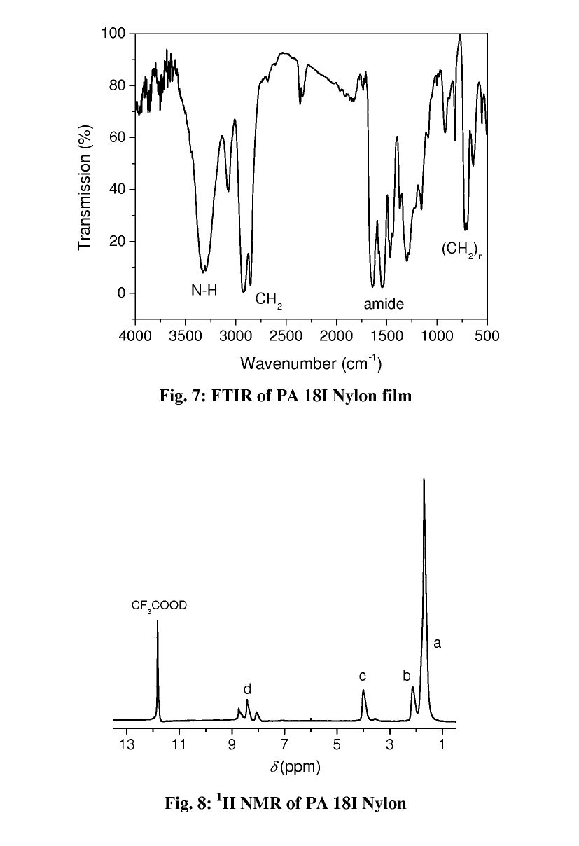

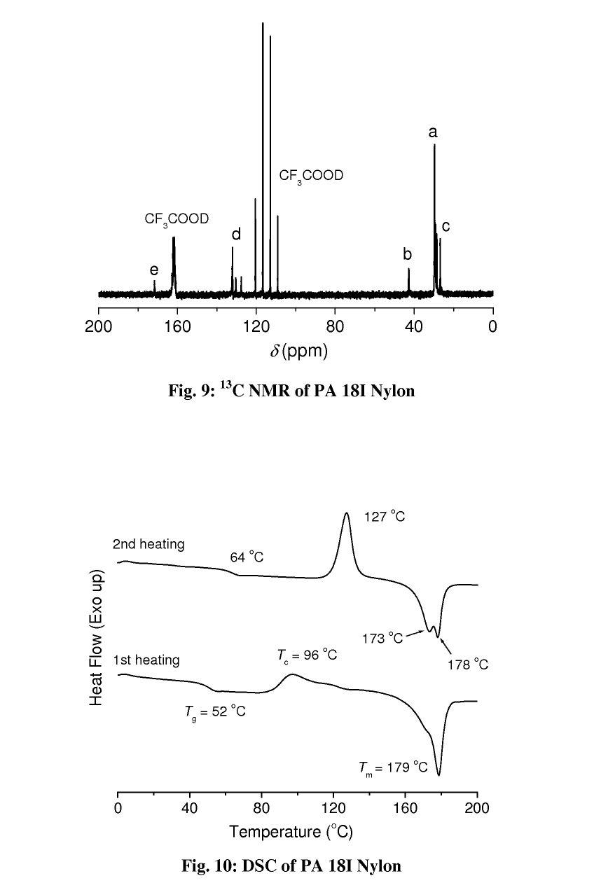

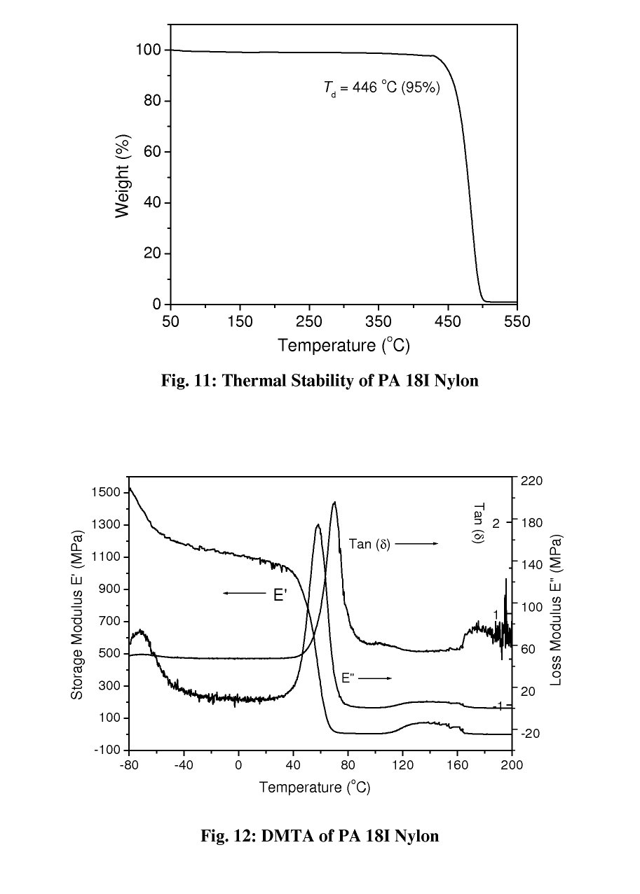

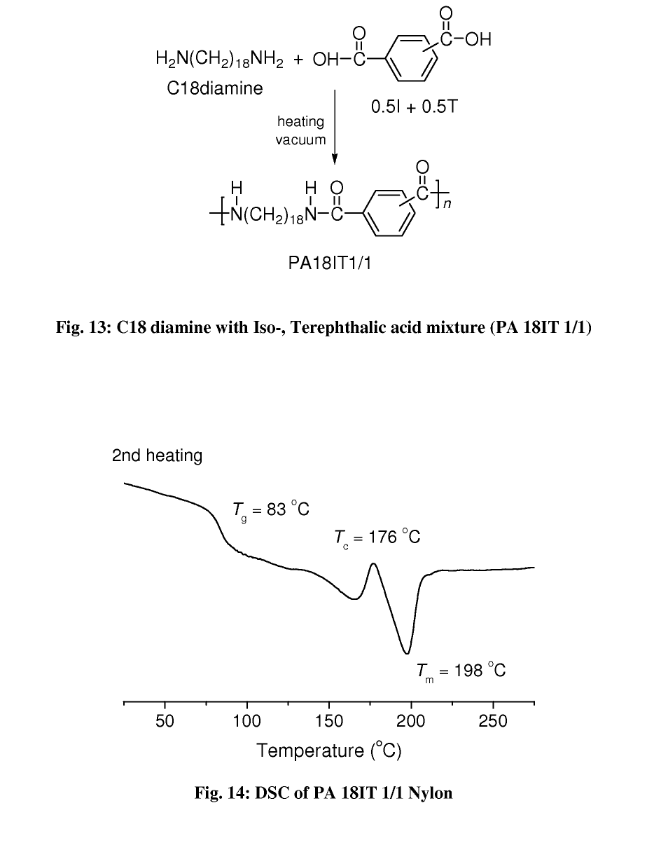

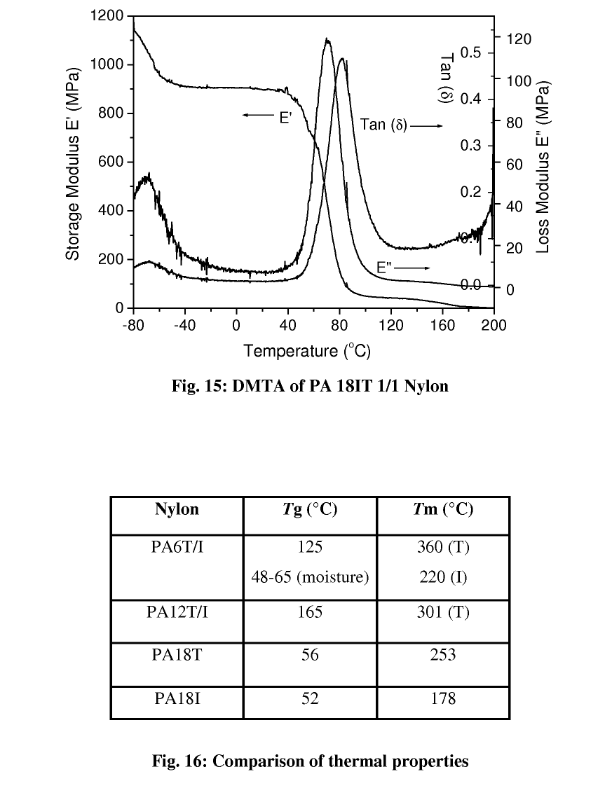

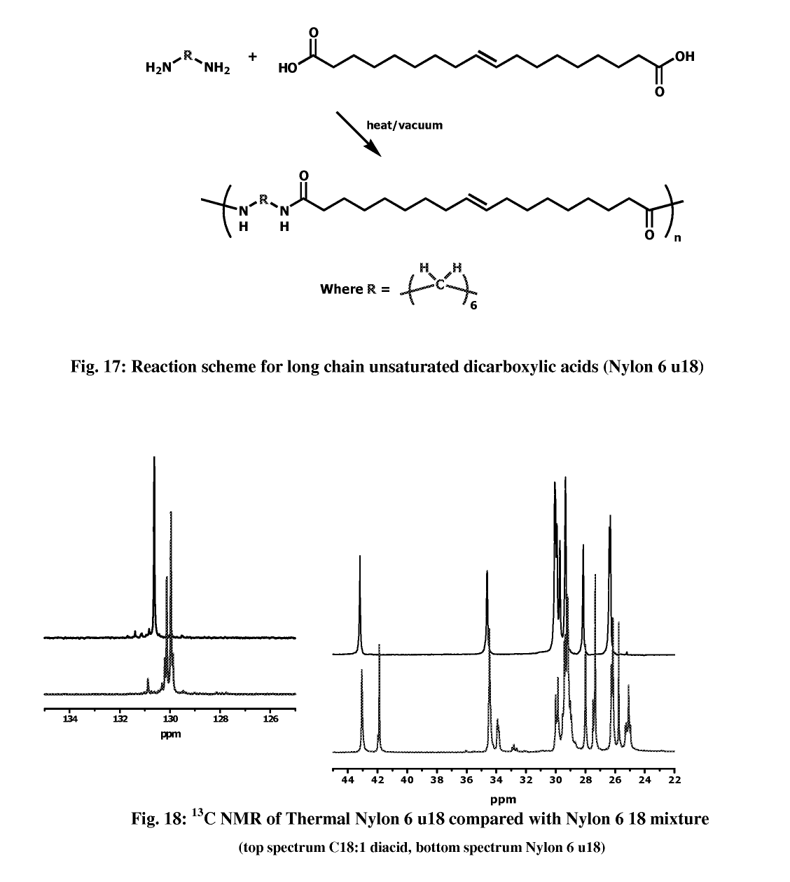

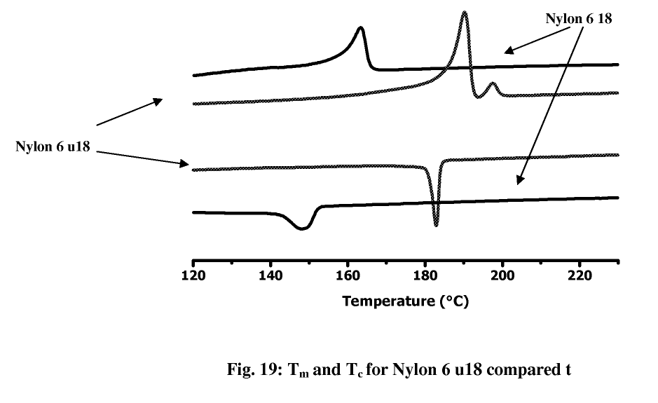

### DETAILED DESCRIPTION OF THE INVENTION

As used herein, the terms “comprises”, “comprising”, “includes”, “including”, “has”, “having”, or any other variation thereof, mean that other elements or components may be included. For example, a process, method, article, or apparatus that comprises a list of elements is not necessarily limited to the expressly listed elements, but may include other elements inherent, or not expressly listed, to such process, method, article, or apparatus. In addition, unless expressly stated to the contrary, the term “or” refers to an inclusive “or” and not to an exclusive “or”. For example, the condition A “or” B is satisfied by any one of the following: A is true (included) and B is false (omitted); A is false (omitted) and B is true (included); and both A and B are true (both included).

The terms “a” or “an” are used to describe elements and components of the invention. This is done for convenience to the reader and to provide a general sense of the invention. The use of “a” or “an” should be understood to include one or at least one. In addition, the singular also includes the plural, unless indicated to the contrary. For example, reference to a composition containing “a compound” includes at least one or more compound(s).

The polyamide is prepared by reacting a long chain (at least 18 carbon atoms) unsaturated or saturated, dicarboxylic acid and hexamethylene diamine. The diacid is produced via a bio-oxidation route. The bio-oxidation route is a process by which oleic acid is fermented using a strain of Candida tropicalis yeast to produce a dibasic acid with 18 carbon atoms. Upon the completion of the fermentation process, the dibasic acid is removed from the fermentation broth and purified into a final product which is used as a monomer building block for the polyamides according to an aspect of the invention. The process to produce a C₁₈ diacid via the bio-oxidation process is described in U.S. Pat. No. 6,569,670, the entire contents of which are hereby incorporated by reference herein, and which are summarized below.

The fermentation medium facilitates the bioconversion of various types of organic substrates, and contains the following components: (i) a source of metabolizable carbon and energy; (ii) a source of inorganic nitrogen; (iii) a source of phosphate; (iv) at least one metal selected from the group consisting of alkali metals, alkaline earth metals, and mixtures thereof, and (v) a source of biotin, substantially free of particulate matter and bacteria.

Suitable sources of metabolizable carbon and energy include, but are not limited to: glucose, fructose, maltose, glycerol, sodium acetate, methanol, short chain alcohols, and mixtures thereof. Inorganic sources of nitrogen include, but are not limited to: alkali metal nitrates, including sodium or potassium nitrate, ammonium salts, including ammonium sulfate, ammonium chloride, ammonium nitrate, and ammonium acetate. A suitable source of phosphate includes any phosphate-containing compounds, for example, potassium phosphate, sodium phosphate, and ammonium phosphate. Suitable metals for use in the fermentation medium include alkali metals, alkaline earth metals, transition metals, and mixtures thereof. A suitable combination may include potassium, calcium, and magnesium. The remaining component of the fermentation medium is biotin, which should be substantially free of particulate matter and bacteria, to avoid problems associated with odor emission, color instability, and contamination.

The water present in the fermentation medium may be a process water purified by distillation, deionization, or softening. Suitable sources of water include those from a municipal water distribution system, a process recycle stream, or well water wherein adjustments in mineral content may need to be taken into account for minerals already contained in these sources of water. For example, the water together with other required ingredients may already contain sufficient mineral components to provide all or substantially all the required minerals for growth of the organism.

Various types of auxiliary components may also be included in the fermentation medium to further enhance the biofermentation process, for example, various types of trace metals, chelating agents, and anti-foaming agents.

The process for making a diacid for use according to an aspect of the invention may be operated over any pH range where the microorganism can grow and catalyze the desired conversion reaction. A suitable pH range is from about 7 or less. Suitable pH control reagents are ammonia, ammonium hydroxide solution, concentrated potassium or sodium hydroxide. A cosubstrate used in the process is a fermentable carbohydrate such as glucose, fructose, or maltose, or other fermentable organic compound, for example, glycerol, sodium acetate, methanol, short chain alcohols, or mixtures thereof.

It is convenient, but not necessary, if the carbon and energy source used to grow the biomass is the same as the cosubstrate used to drive the oxidative conversion reaction. The practical benefit is that fewer raw materials need be handled and the various stages of the fermentation can be well integrated. For example, a single cosubstrate sterilization and delivery system can be used to deliver both the carbon and energy source to grow the biomass and the cosubstrate to drive the oxidation reaction.

The microorganism that can be used in the process according to an aspect of the invention includes any Candida strain where beta oxidation is partially or completely disrupted by inactivation or deletion of one or more acyl CoA oxidase gene(s).

Yeast strains known to excrete alpha, omega-dicarboxylic acids as a by-product when cultured on alkanes or fatty acids as the carbon source are set forth in U.S. Pat. No. 5,254,466, the entire contents of which are herein incorporated by reference. These strains are partially or completely oxidation-blocked strains, i.e., the strains are genetically modified so that the chromosomal POX4A, POX4B, and both POX5 genes have been disrupted. The substrate flow in this strain is redirected to the omega-oxidation pathway as the result of functional inactivation of the competing beta-oxidation pathway by POX gene disruption. A completely oxidation-blocked strain is a C. tropicalis strain, strain H5343 (ATCC 20962), as described in U.S. Pat. No. 5,254,466.

Another suitable strain includes one or more amplified reductase genes, which results in an increased amount of rate-limiting omega-hydroxylase through P450 gene amplification and an increased rate of substrate flow through the omega-oxidation pathway. Strains which selectively increase the amount of enzymes known to be important to the oxidation of fatty acids contain increased copies of the CYP and CPR genes, which have been identified as relating to the production of the omega-hydroxylase complex, and catalyzing the first step in the oxidation pathway. Strain HDC1 is an example of a strain that contains multiple copies of the CYP 52A2A gene integrated into the genome of strain H5343. This strain and similar strains are described in provisional application Ser. No. 60/083,798, filed on May 1, 1998, now U.S. Pat. Nos. 6,331,420, 7,049,112, and 7,063,972, the entire contents of which are incorporated herein by reference. Other strains that can be used with the methods of this invention are Candida tropicalis strains HDC1, HDC5, HDC10, HDC15, HDC20, HDC23, HDC 23-1, HDC 23-2, and HDC 23-3, as described in International Application No. PCT/US99/20797, the entire content of which is hereby incorporated by reference.

The fermentation process can be modified by utilizing a triglyceride fat or oil as the source of both the organic substrate and cosubstrate. A lipase, formulated with the fermentation broth, hydrolyzes (splits) the fat or oil into fatty acids and glycerine. Glycerine consumption by the organism drives the splitting reaction to completion, while supplying the energy necessary to convert the free fatty acids to their corresponding dibasic acids. Lipases that are oleo-specific are particularly suitable. Oleo-specific lipases exhibit a high selectivity for a triglyceride with high oleic acid content and selectively catalyze the hydrolysis of the oleate ester groups. Examples of such oleo-specific lipases include, but are not limited to the lipases produced by Pseudomonas sp, Humicola lanuginosa, Candida rugosa, Geotrichum candidum, and Pseudomonas (Burkholderia). A particularly suitable lipase is UNLipase from Geotrichum candidum ATCC No. 74170, as described in U.S. Pat. No. 5,470,741, the entire contents of which are incorporated herein by reference.

In the growth stage, a culture medium is inoculated with an active culture of beta-oxidation blocked microorganism such as a beta-oxidation blocked Candida tropicalis strain where a period of rapid exponential growth occurs. The pH of the culture medium is controlled by the addition of base, for example, ammonium hydroxide, potassium hydroxide, sodium hydroxide, or ammonia gas. The cosubstrate addition to the fermenter may be fed-batch during the conversion phase. The end of exponential growth phase is marked by a depletion of glucose, a rapid increase in dissolved oxygen, and by a rapid increase in offgas oxygen and decrease in offgas CO₂.

The conversion phase where the substrate is oxidized is initiated by adding an inducer and the substrate containing an oxidizable methyl group. During conversion, the fermentation broth is in a pH range of between 2 and 7. The fermentation can be carried out at a temperature of from about 26° C. to about 40° C.

According to an aspect of the invention, a suitable dicarboxylic acid includes, but is not limited to: 1,18-octadecenedioic-9 acid, and 1,18-octadecenedioic acid. Another suitable dicarboxylic acid includes 1,16-hexadecenedioic acid. Suitable aromatic dicarboxylic acids according to the present invention are for examples terephthalic acid, iso-terephthalic acids and mixture thereof. However, preferred diacids are non-aromatic diacids, and in particular those prepared by bio-oxidation processes.

The diacid is made through a bio-oxidation process starting from the corresponding mono acid. For example, a diacid with 18 carbon atoms is produced from a monoacid with 18 carbon atoms with the same degree of unsaturation (or saturation) via the bio-oxidation fermentation process.

According to another aspect of the invention, a suitable diamine includes hexamethylene diamine. Other suitable dimer diamines include compounds corresponding to the formula H₂N—R—NH₂, where R is an aromatic or alkyl group with 6-10 carbon atoms.

Advantageously, the reactive sites (unsaturation) are preserved during polymerization, and can be further reacted. Examples of further reactions or applications include polymer surface chemical modification and cross-linking. For example, the double bond can be epoxidized by H₂O₂, or O₂, and converted to an —OH group, which can be further reacted with EO or other functional groups.

According to another aspect of the invention, a method for making a polyamide includes the steps of: reacting equimolar quantities of a dicarboxylic acid comprising 18 carbon atoms with a diamine in a reactor. After removing the residual air by vacuum and purging the reactor with N₂, the reaction mixture is heated under vacuum to a temperature of 250-350° C. When the reaction is completed, (the desired molecular weight or viscosity is reached), the reaction product is discharged and cast into a desired shape, or spun into a fiber.

A general reaction scheme to form a polyamide according to an aspect of the invention may be illustrated as follows:

nHOOC—(CₓH_{2x-2y})—COOH+nH₂N—(CₐH_{2a-2b})—NH₂→H₂O↑+HO—[OC—(CₓH_{2x-2y})—CONH—(CₐH_{2a-2b})—NH]ₙH

where n is an integral number from 30 to 10000, a and x=6-32 and b and y are 0 or 1-12.

A more specific reaction scheme to form Nylon 6, 18:1, using 1,18-octadecenoic-9 acid and hexamethylene diamine, may be illustrated as follows:

nHOOC—(CH₂)₇—CH═CH—(CH₂)₇—COOH+nH₂N—(CH₂)₆—NH₂→H₂O↑+HO—[OC—(CH₂)₇—CH═CH—(CH₂)₇—CONH—(CH₂)₆NH]ₙH

where n is an integral number from 30 to 10,000. The by-product, water, is removed by vacuum during the reaction.

In another aspect of the invention, an example of the reaction scheme may be illustrated as follows:

aHOOC—(CH₂)₁₆—COOH+bHOOC—C₆H₄—COOH+nH₂N—(CH₂)₆—NH₂→H₂O+HO—{[OC—(CH₂)₁₆—CONH—(CH₂)₆NH]ₓ—[CO—C₆H₄—CONH—(CH₂)₆NH]_{y}}_{a+b}—H

where a+b=n; a, b, n are integral numbers; n represents a number from 30 to 10,000.

In another aspect of the invention, a long chain diacid or diamine and aromatic component may be illustrated as follows:

aHOOC—R₁—COOH+bHOOC—R₂—COOH+mH₂N—R₃—NH₂+nH₂N—R₄—NH₂→H₂O+HO—{[OC—R₁—CONH—R₃—NH]ₓ—[CO—R₂—CONH—R₄₋—NH]_{y}—[OC—R₁—CONH—R₄—NH]_{c}—[CO—R₂—CONH—R₃₋—NH]_{d}}—H

where R₁ and R₃ are aliphatic and have chains of 4 to 22 carbon atoms; R₂ and R₄ are aromatic and have chains of 6 to 20 carbon atoms; c, d, x, and y are integral numbers, and the sum of x+y+c+d equals 30 to 10,000.

Nylon may be prepared from long chain dicarboxylic acid (saturated and/or unsaturated) and diamine(s). Including an aromatic diacid and/or diamine will modify crystallinity, glass transition temperature (T_{g}) and other properties, including as a major advantage optical clarity. It is one advantage of the present invention that Nylon, or other polyamides, using long chain dicarboxylic acids, prepared by biooxidation as described above, show higher clarity as those polyamides in particular Nylon, using long chain dicarboxylic acids, prepared by standard chemical methods. Optically clear polyamides may be used in medical applications and in food packaging.

Including an aromatic monomer, for example, a diacid or diamine, may also increase the modulus and melting temperature (Tₘ).

A metabolically-engineered strain of Candida tropicalis (as described above) may be used to oxidize a terminal methyl group on the end of an aliphatic carbon chain. Using the process, the diacid yield from inexpensive alkanes and fatty acid feedstocks is significantly enhanced, and is of high quality to meet the stringent specification requirements of the polymer industry.

According to an aspect of the invention, production of diacids using bioconversion overcomes some of the disadvantages of the current chemical synthesis processes. Among the advantages inherent in all biological conversion processes is the ability to use renewable resources as starting materials for the process rather than petrochemicals, and the ability to produce chemicals without also producing a hazardous waste stream. For example, diacids may be produced from inexpensive long-chain fatty acids, which are readily available from renewable agricultural and forest products such as soybean oil, tallow, corn oil, and tall oil, without the production of the dangerous waste products discussed above.

Only one step is required to produce diacids using a biological process. Moreover, a bioconversion process can be adapted easily to produce a wide range of diacids, since the biocatalyst accepts a variety of starting materials. Therefore, a bioconversion method can produce diacids of different lengths which were previously unavailable using chemical synthesis.

A biocatalyst can produce diacids with long carbon chain lengths. Diacids with 16 or 18 carbon atoms can be produced using a bio-oxidation process. The longer carbon chain diacids are effective at lowering of melt viscosity in the polyamides and polyesters, at a lower diacid concentration than a diacid with 12 carbon atoms, and are thus more economical to use. Using prior art methods, however, these longer chain diacids cannot be produced commercially and are currently unavailable for widespread use.

Biological conversion processes have the potential to produce diacids for a lower cost than the currently available chemical process. To do this, any biotechnological process must be able to utilize inexpensive, easily available organic substrates as starting materials, and convert those substrates to the desired diacid product with high efficiency.

The biological conversion process for production of long chain aliphatic diacids is carried out by batch fermentation. The batch fermentation process consists of two phases: growth and conversion (or transformation). The growth phase is initiated by inoculating a batch fermenter containing a nutrient medium with the yeast biocatalyst. During this phase of the process, the cells increase in number to a cell density which is dependent on many factors, including the cell type and the nutrient content of the medium. Growth continues in the batch fermenter under selected conditions for a selected period of time or until a selected cell density is reached, at which time the fatty acid, fatty acid ester, or alkane substrate is added to initiate the conversion phase, during which the desired product is formed. During conversion, an excess of substrate is always maintained. A carbon source (co-substrate) such as glucose is also added throughout the conversion phase to provide an energy source for the yeast. When conversion is completed, the yeast biomass is separated from the fermentation medium, and the diacid product is recovered and purified from the solution.

According to another aspect of the invention, a long chain diacid can be converted to a fatty diamine, and the resulting diamine is reacted with an aliphatic or aromatic diacid. For example, a diacid with 18 carbon atoms was reacted with NH₃ to form an ammonium salt. The ammonium salt was dehydrated to form a dinitride with 18 carbon atoms. The dinitride was subsequently converted into a 1,18 diamine by hydrogenation.

In one aspect, an 18 carbon aliphatic diamine may be reacted with an aromatic diacid to form a polyamide. For example, a C₁₈ diamine may be reacted with terephthalic acid, isophthalic acid, and mixtures thereof. The result is improved thermal and mechanical properties.

Polyamide samples prepared were 2,18; 3,18; 4,18; 6,18; 8,18; 9,18; and nylon 6/6,18 copolymers (0-100%). Advantageously, the nylon prepared from the 1,18 dicarboxylic acid, particularly nylon 6,18 and 6/6,18, exhibited improved moisture, abrasion, and fatigue resistance in comparison with currently available materials. Therefore, the nylon prepared from 1,18 dicarboxylic acid are suitable for use, for example, in toothbrushes, abrasive brushes, painting brushes, and other brush applications.

In addition, the polyamides prepared also are transparent and have good adhesion properties with polyolefins, for example, polypropylene. The properties of the polyamides render them suitable for use as a packaging material, whether individually or in combination with other materials, in food, medicine, and cosmetic applications.

Applications for the long-chain diacid include nylon engineering plastics, nylon fibers, nylon films for food and medical packaging, polyamide and polyester hot melt adhesives, glycidyl methacrylate (GMA), powder coatings, cross-linkers, lubricant base stocks, greases, and corrosion inhibitors, polyurethanes, and cosmetics.

Unless otherwise defined, all technical and scientific terms used herein have the same meaning as commonly understood by one of ordinary skill in the art to which the invention belongs. Although methods and materials similar or equivalent to those described herein can be used in the practice or testing of the invention, suitable methods and materials are described below. The materials, methods and examples disclosed herein are illustrative only, and are not intended to be limiting.

The invention has been described with reference to specific embodiments. One of ordinary skill in the art, however, will appreciate that various modifications and changes can be made without departing from the scope of the invention as set forth in the claims. Accordingly, the specification is to be regarded in an illustrative manner, rather than with a restrictive view, and all such modifications are intended to be included within the scope of the invention.

Benefits, advantages, and solutions to problems have been described above with regard to specific embodiments. The benefits, advantages, and solutions to problems, and any element(s) that may cause any benefit, advantage, or solution to occur or become more pronounced, are not to be construed as a critical, required, or an essential feature or element of any or all of the claims.

What is claimed is:

1. A polyamide according to:
(A) formula (I):
HO—[OC—(CH₂)₇—CH═CH—(CH₂)₇—CONH—(CH₂)ₘNH]ₙH (I)
wherein m is an integral number from 4 to 20, and n is an integral number from 30 to 10,000; or
(B) formula (II):
HO—[OC—(CₓH_{2x-2y})₇—CONH—(CₐH_{2a-2b})NH]ₙH (II)
wherein n is an integral number from 30 to 10000, a and x each independently represent a value from 6-32, and b and y each independently represent a value from 0-12.

2. The polyamide according to claim 1(A), wherein m is an integral number from 6 to 18.

3. (canceled)

4. A polyamide according to:
(A) formula (III):
HO—{[OC—(CH₂)₁₆—CONH—(CH₂)₆NH]ₓ—[CO—C₆H₄—CONH—(CH₂)₆NH]_{y}}_{a+b}—H (III)
wherein a+b=n; a, b, and n are integral numbers; and n represents a number from 30 to 10,000, x represents a value from 6-32, and y represents a value from 0-12; or
(B) formula (IV):
HO—{[OC—R₁—CONH—R₃—NH]ₓ—[CO—R₂—CONH—R₄₋—NH]_{y}—[OC—R₁—CONH—R₄—NH]_{c}—[CO—R₂—CONH—R₃₋—NH]_{d}}—H (IV)
wherein R₁ and R₃ are aliphatic with chains of 4 to 22 carbon atoms; R₂ and R₄ are aromatic and have chains of 6 to 20 carbon atoms; c, d, x, and y are integral numbers, and the sum of c+d+x+y equals 30 to 10,000.

5. (canceled)

6. The polyamide of formula (I) of claim 1, wherein the dicarboxylic acid moiety comprises a linear dicarboxylic acid prepared by a bio-oxidation process.

7. The polyamide of claim 6, wherein said dicarboxylic acid moiety is selected from the group consisting of linear unsaturated dicarboxylic acids with 18 carbon atoms.

8. The polyamide of claim 6, wherein said dicarboxylic acid is selected from the group consisting of 1,18-octadecenedioic-9 acid, 1,18-octadecenedioic acid, 1,16-hexadecenedioic acid and mixtures thereof.

9. A method for preparing a polyamide, comprising the steps of:
(a) mixing equimolar quantities of a dicarboxylic acid with a diamine in a reactor;
(b) removing residual air by vacuum and purging with N₂; and
(c) heating under vacuum at 250-350° C.

10. The polyamide of claim 6, wherein said linear dicarboxylic acid is unsaturated.

11. The polyamide of claim 4(A), prepared by reacting a mixture of a equivalents of HOOC—(CH₂)₁₆—COOH, plus b equivalents of HOOC—C₆H₄—COOH, and n equivalents of H₂N—(CH₂)₆—NH₂.

12. The polyamide of claim 4(B), prepared by reacting a mixture of HOOC—R₁—COOH, plus HOOC—R₂—COOH, plus H₂N—R₃—NH₂ and H₂N—R₄—NH₂.
